(19) United States
(12) Patent Application Publication
(10) Pub. No.: US 2025/0358075 A1
(43) Pub. Date: Nov. 20, 2025

(54) PUSCH FREQUENCY HOPPING ENHANCEMENTS

(71) Applicant: INTERDIGITAL PATENT HOLDINGS, INC., Wilmington, DE (US)

(72) Inventors: Joe Huang, Montville, NJ (US); Sudhir Pattar, Mount Laurel, NJ (US); Daniel Steinbach, Commack, NY (US); Phillip Leithead, King of Prussia, PA (US)

(73) Assignee: INTERDIGITAL PATENT HOLDINGS, INC., Wilmington, DE (US)

(21) Appl. No.: 18/666,561

(22) Filed: May 16, 2024

(51) Int. Cl. H04L 5/00; H04B 1/713; H04W 72/0453

(52) U.S. Cl. CPC H04L 5/0053; H04B 1/713; H04W 72/0453

(57) ABSTRACT

A wireless transmit receive unit (WTRU) and methods for enhancing PUSCH frequency hopping transmission in the presence narrowband interferes are disclosed. The method may include: by a network element, determining an interference signal, determining the interference signal is equal to or greater than a threshold value, determining one or more WTRUs capable of incurring the interference signal at a level equal to or greater than the threshold value, generating information indicating PRB exclusion, generating a signal to trigger the PUSCH frequency hopping with PRB exclusion; and, by one or more WTRUs, receiving the information indicating the PRB exclusion, storing the information indicating the PRB exclusion, receiving the signal to trigger the PUSCH frequency hopping with PRB exclusion, retrieving a most recently stored information indicating the PRB exclusion when the signal to trigger the PUSCH frequency hopping with PRB exclusion is received, and transmitting a frequency hopping PUSCH with PRB exclusion.

### BACKGROUND

Recent trends are driving researchers to create solutions for cellular network deployments in the presence of high-power narrowband interferers. For example, cellular network deployments in and around an airport may experience interference from RADAR, and the RADAR may experience interference from the cellular network. Baseline functionality provided by 5G may provide some level of operational coexistence with RADARs. However, enhancements will be required to realize the full potential or 5G operating in the presence of high-power narrowband interferers.

When a narrow-band high power interferer, for example RADAR, operates in a band that overlaps with the RBs used by a WTRU to transmit frequency hopped PUSCH, the gNB may not be able to reliably receive data radio bearer (DRB) signaling and radio bearer (SRB) traffic on the uplink. In addition, uplink control information (UCI) such as HARQ ACK/NACK feedback for the downlink transmission and downlink channel state information (CSI) feedback may also be transmitted over the PUSCH channel and may not be able to be reliability received. Furthermore, there is the potential for the frequency hopped PUSCH transmission to interfere with, for example, a RADAR system which is also problematic. Therefore, there is a need for new mechanisms to ensure robust and efficient PUSCH frequency hopping transmission and reception when a wireless communication network coexists with narrow-band high power interferer such as RADAR.

### SUMMARY

Aspects, features and advantages of the disclosed embodiments ensure robust and efficient PUSCH transmission and reception in the presence of high-power narrowband interferers such as RADAR interference. Aspects and features may apply to a method of triggering PUSCH frequency hopping transmission, the method including: identifying, by a network element, an interference signal; determining, by the network element, the interference signal is equal to or greater than a threshold value; determining, by the network element, one or more wireless transmit/receive units (WTRUs) capable of incurring the interference signal at a level equal to or greater than the threshold value; and generating, by the network element, PRB exclusion information, the PRB exclusion information identifying PRBs excluded from PUSCH frequency hopping transmission. The method includes: receiving, by the one or more WTRU's, the PRB exclusion information; storing, by the one or more WTRUs, the PRB exclusion information; generating, by the network element, a signal to trigger the PUSCH frequency hopping transmission with PRB exclusion; receiving, by the one or more WTRUs, the signal to trigger the PUSCH frequency hopping transmission with PRB exclusion; retrieving, by the one or more WTRUs, a most recently stored information PRB exclusion information when the signal to trigger the PUSCH frequency hopping transmission with PRB exclusion is received; and transmitting, by the one or more WTRU's, a frequency hopping PUSCH with PRB exclusion.

In addition, Aspects and features may apply to a WTRU, the WTRU including: a receiver configured to: receive, from a network element, PRB exclusion information, the PRB exclusion information identifying PRBs excluded from PUSCH frequency hopping transmission, and receive, from the network element, a signal to trigger PUSCH frequency hopping with PRB exclusion; a processor configured to: store the received PRB exclusion information, and retrieve a most recently stored PBR exclusion information when the signal to trigger the PUSCH frequency hopping with PRB exclusion is received; and a transmitter configured to transmit a frequency hopping PUSCH with PRB exclusion according to the most recent PBR exclusion information.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a potential scenario of a wireless network encountering interference from RADAR;

FIG. 3 illustrates an exemplary system for sensing RADAR information;

FIG. 4 is an exemplary illustration of PRB exclusion;

FIG. 5 is a flow diagram of an exemplary process of excluding PRBs from an active BWP performed at a WTRU; and

FIG. 6 is a flow diagram of an exemplary process of excluding PRBs from an active BWP performed at a network element.

### DETAILED DESCRIPTION

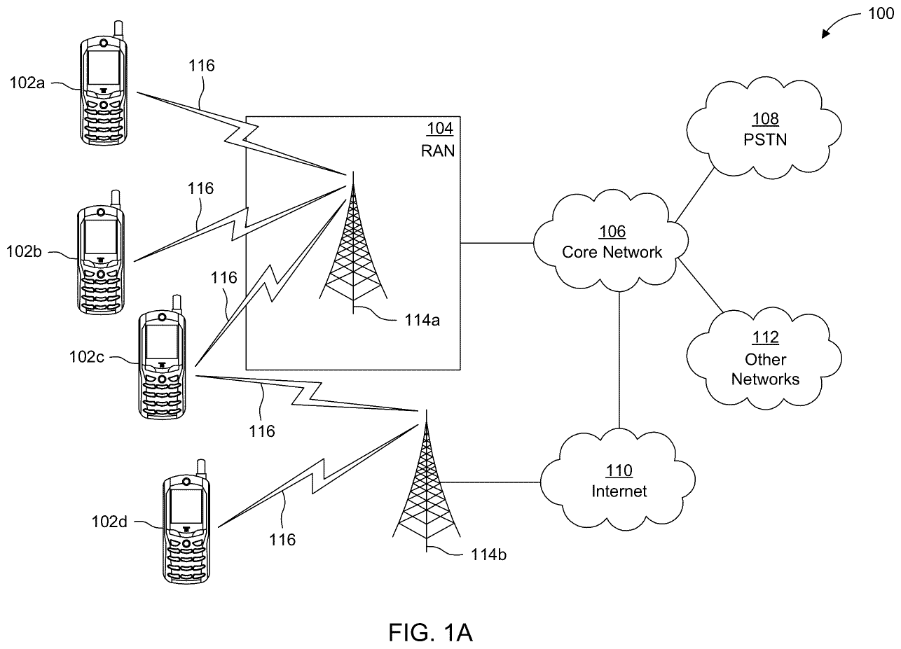

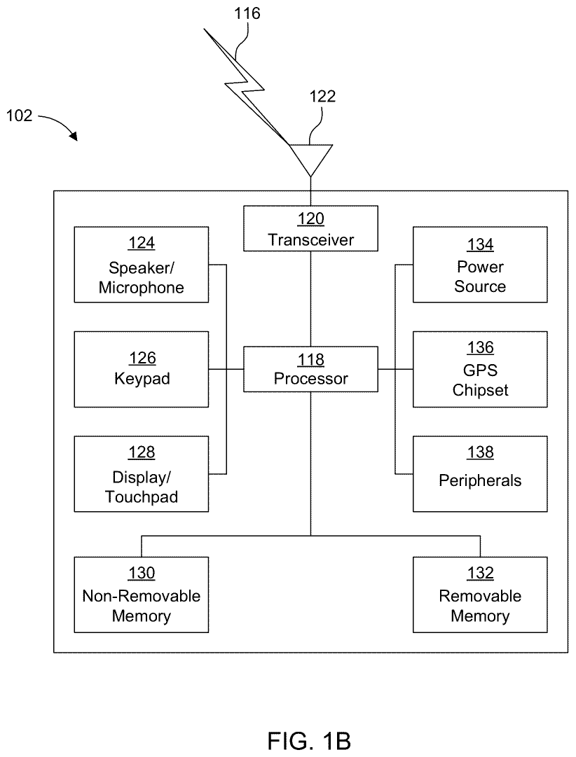

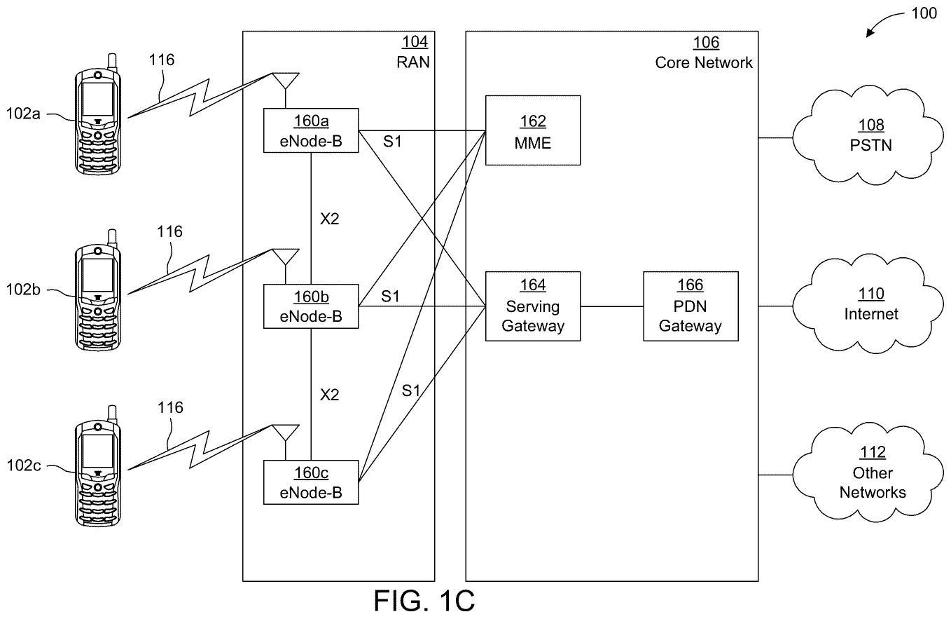

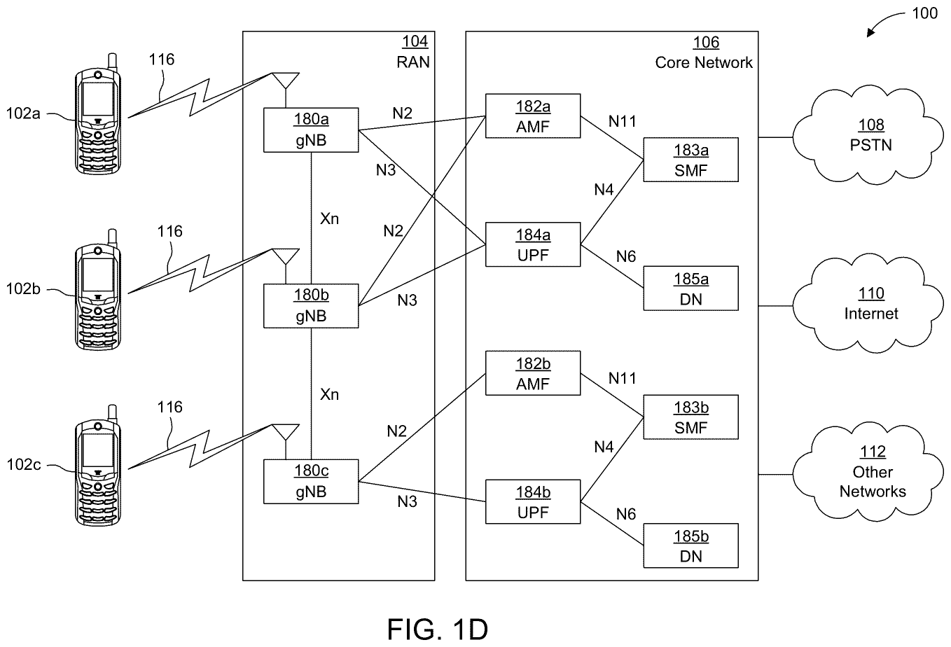

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR. NR is a radio access that may be used with 5G.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations may be referred to herein:
3GPP Third Generation Partnership Project
5G 5th Generation
AOA Angle of Arrival
BW Bandwidth
BWP Bandwidth Part
CG Configured Grant
CRC Cyclic Redundancy Check
C-RNTI Cell Specific Radio Network Temporary Identifier
CI-RNTI Cancellation Indicator Radio Network Temporary Identifier
CP-OFDM Cyclic Prefix OFDM
CS-RNTI Configured Scheduling Radio Network Temporary Identifier
CSI Channel State Information
DCI Downlink Control Information
DFT-S-OFDM Discrete Fourier Transform-Spread OFDM
DL Downlink
DMRS Demodulation Reference Signal
DRB Data Radio Bearer
eLCID Extended Logic Channel ID
eMTC Enhanced Machine Type Communication
ENSURED-5G Enhanced Security and Co-Existence for DoD-5G
FR1 Frequency Range 1
FR2 Frequency Range 2
gNB Next Generation (5G) NodeB
LCID Logic Channel ID
MAC Medium Access Control
MAC-CEMAC Control Element
MCS Modulation and Coding Scheme
MCS-C-RNTI Modulation and Coding Scheme Cell Specific Radio Network Temporary Identifier
NB-IoT Narrow Band Internet of Things
NDI New Data Indicator
NR New Radio
OFDM Orthogonal Frequency Division Multiplexing
PDCCH Physical Downlink Control Channel
PHY Physical Layer
PRACH Physical Random Access Channel
PRB Physical Resource Block
PSD Power Spectral Density
PUCCH Physical Uplink Control Channel
PUSCH Physical Uplink Shared Channel
QOS Quality of Service
RADAR Radio Detection and Ranging
RAR Random Access Response
RB Resource Block
RBG Resource Block Group
RE Resource Element
RIV Resource Indication Value
RRC Radio Resource Control
SCS Subcarrier Spacing
SLIV Start and Length Indicator Value
SRB Signaling Radio Bearer
TB Transport Block
TC-RNTI Temporary Cell Specific Radio Network Temporary Identifier
UCI Uplink Control Information
UE User Equipment
UL Uplink
URLLC Ultra Reliable Low Latency Communication

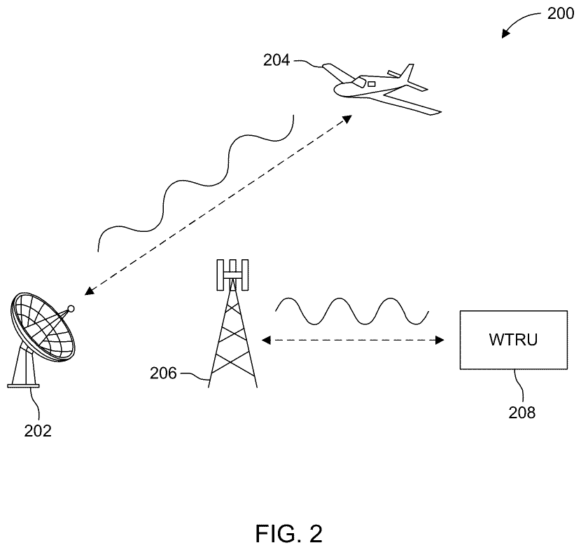

Referring to FIG. 2, an example potential interference scenario 200 is shown where communications between a base station 206 and a remote WTRU 208 may be adversely impacted by the presence of narrowband interferers, such as RADAR station 202 and/or RADAR on plane 204 (or reflections therefrom). The example embodiments that follow, address potential interference avoidance solutions for PUSCH communications between WTRU 208 and base station 206.

### PUSCH Time-Domain Repetition

In 5G NR, PUSCH time-domain resource allocation (TDRA) for data transmission is dynamically signaled in the DCI. This is useful as part of the slot available for uplink transmission and may vary from slot to slot as a result of the use of dynamic TDD or the amount of resources used for uplink control signaling. Furthermore, the slot in which the transmission occurs may need to be signaled as part of the time-domain allocation. Although downlink data are often transmitted in the same slot as the corresponding DCI assignment, this frequently may not the case for uplink transmissions.

As an example, DCI formats 0_0 and 0_1 are used for dynamic PUSCH time-domain resource allocation. They carry an up to 4-bit ‘Time-domain resource allocation’ field which points to one of the rows of an up to 16-row look-up table where each row provides the following parameters, slot offset K₂ may be used to indicate the offset to the slot for PUSCH transmission, SLIV (jointly coded Start and Length Indicator Values), may be used to derive values for the start symbol ‘S’ and the allocation length ‘L’, and ‘PUSCH mapping type’ may be to be applied on the PUSCH transmission, Type A or Type B, which determines the first DM-RS symbol position.

In view of this the RRC IE PUSCH-TimeDomainResourceAllocation may be used to determine a time-domain offset between PDCCH and PUSCH. PUSCH-TimeDomainResourceAllocationList lists up to 16 PUSCH-TimeDomainResourceAllocations. A WTRU may determine the bit width of the DCI field based on the number of entries in the PUSCH-TimeDomainResourceAllocationList. The DCI may indicate which of the configured time-domain allocations the WTRU may use for that UL grant.

Another aspect of the uplink (UL) time-domain resource allocation is PUSCH slot repetition, also called PUSCH slot aggregation or PUSCH slot bundling. The motivation for introducing slot repetition is to improve UL coverage and link budget. The same transport block (TB) is repeated in the bundled slots. PUSCH slot bundling may be enabled when the UE is configured with pusch-AggregationFactor, in which case the same symbol allocation may be applied across the pusch-AggregationFactor consecutive slots with pusch-AggregationFactor set to 2, 4, or 8, in response to a single received UL grant.

In addition, configured grants may be used to facilitate uplink transmissions without a dynamic grant in order to reduce control signaling. Two types of configured grants may be supported, differing in the ways they are activated. These may include: 1, Configured grant type 1, where an uplink grant is provided by RRC, including activation of the grant, and 2, Configured grant type 2, where the transmission periodicity is provided by RRC and L1/L2 signaling is used to activate the transmission. NR also supports slot aggregation for PUSCH transmissions with configured grants. Slot aggregation with configured grants may be configured via RRC signaling using the parameter repK within ConfiguredGrantConfig IE for the case of configured grant. This field may be mandatorily present and take values of 1, 2, 4, and 8. Slot aggregation is activated when repK>1.

A DCI format 0_2 may be introduced for enhanced flexibility in the field size, which can carry up to 6-bit ‘Time-domain resource allocation’ corresponding to up to a 64-row look-up table in RRC. The ‘Time-domain resource allocation’ field in the DCI format 0_2 is used as an index into an RRC configured table from which the time-domain allocation is obtained. Each row contains at least: A slot offset (K₂), that is, the slot relative to the one where DCI was received. In the uplink, the slot offsets from 0 to 7 may be used. The relatively large slot offset, as compared to the downlink (0 to 3), is motivated by the need to schedule uplink transmission further into the future for coexistence with LTE TDD, the first OFDM symbol (S) in the slot where the data are transmitted, and the duration of the transmission in number of OFDM symbols (L) in the slot.

It is noted that default time-domain resource allocation tables may be used if no table is configured. These default tables may be used until the necessary table configuration is provided. In many cases, the default table may be sufficient, in which case there may be no need to configure other values. Furthermore, additional columns may be configured in a table. For example, to better support URLLC, the number of times a transmission may or should be repeated can be configured. Thus, it is possible to indicate slot aggregation (PUSCH repetition Type A) in a dynamic manner by properly configuring numberOfRepetitions-r16 in a time-domain resource allocation table.

For PUSCH repetition Type A, the starting symbol S relative to the start of the slot, and the number of consecutive symbols L counting from the symbol S allocated for the PUSCH are determined from the start and length indicator SLIV of the indexed row:

```
if (L − 1) ≤ 7 then
  SLIV = 14 · L − 1) + S
else
  SLIV = 14 · (14 − L + 1) + (14 − 1 − S)
where 0 < L ≤ 14 − S , and
```

For PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetitions K may be determined as: if numberOfRepetitions is present in the resource allocation table, the number of repetitions K is equal to numberOfRepetitions; else if the WTRU is configured with pusch-AggregationFactor, the number of repetitions K is equal to pusch-AggregationFactor, otherwise K=1.

For PUSCH repetition Type A, in case K>1, the same symbol allocation may be applied across the K consecutive slots and the PUSCH may be limited to a single transmission layer. The WTRU may repeat the TB across the K consecutive slots applying the same symbol allocation in each slot. The redundancy version to be applied on the nth transmission occasion of the TB, where n=0, 1, . . . K−1, is determined according to Error! Reference source not found.

TABLE 1

| rv_{id} indicated | rv_{id} to be applied to n^{th} transmission occasion (repetition | | | |
|---|---|---|---|---|
| by the DCI | Type A) or n^{th} actual repetition (repetition Type B) | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

In addition, PUSCH repetition Type B is developed to eliminate time gap among repetitions and because the repetitions are carried out in the consecutive sub-slots so one slot might contain more than one repetition of a transport block. For PUSCH scheduled by DCI format 0_1, if pusch-RepTypeIndicatorDCI-0-1-r16 is set to ‘pusch-RepTypeB’, the UE applies PUSCH repetition Type B procedure when determining the time-domain resource allocation. For PUSCH scheduled by DCI format 0_2, if pusch-RepTypeIndicatorDCI-0-2-r16 is set to ‘pusch-RepTypeB’, the UE applies PUSCH repetition Type B procedure when determining the time-domain resource allocation. Otherwise, the UE applies PUSCH repetition Type A procedure when determining the time-domain resource allocation for PUSCH scheduled by PDCCH.

For PUSCH repetition Type B, the starting symbol S relative to the start of the slot, and the number of consecutive symbols L counting from the symbol S allocated for the PUSCH are provided by startSymbol and length of the indexed row of the resource allocation table, respectively.

For PUSCH repetition Type B, after determining the invalid symbol(s) for PUSCH repetition type B transmission for each of the K nominal repetitions, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of all potentially valid symbols that can be used for PUSCH repetition Type B transmission within a slot. An actual repetition with a single symbol is omitted except for the case of L=1. The UE may repeat the TB across actual repetitions. The redundancy version to be applied on the n^{th} actual repetition (with the counting including the actual repetitions that are omitted) is determined according to Error! Reference source not found.

### PUSCH Frequency-Domain Resource Allocation

In the frequency domain, two resource allocation types, type 0 and type 1, may be supported on the uplink. Type 1 is the default, and for example used with DCI format 0_0. Resource allocation type 0 is a bitmap-based allocation scheme. To reduce control signaling overhead, each bit in the bitmap points to a group of contiguous resource block groups (RBGs). The size of the resource block group is determined by the size of the BWP. On the other hand, resource allocation type 1 may not rely on a bitmap. Instead, it encodes the resource allocation as a start position and length of the resource block allocation, thereby reducing the number of bits required for signaling the resource block allocation. As a result, resource allocation type 1 may only support frequency-contiguous allocations.

Two waveforms are used in the NR uplink: CP-OFDM, when transform precoding is disabled, and DFT-S-OFDM, when transform precoding is enabled. Only resource allocation type 1 may be allowed for DFT-S-OFDM. The reason is that is that resource allocation type 0 allows non-contiguous allocations. That is, the frequency-domain allocation can consist of clusters of PRBs disjoint from each other. The DFT-S-OFDM waveform is fundamentally not designed to work with non-contiguous allocations in the sense that the main benefit of DFT-S-OFDM waveform, namely PAPR reduction, is not preserved once the allocation is non-contiguous.

Non-contiguous allocation is may be problematic for CP-OFDM but for a different reason. There is no PAPR degradation for CP-OFDM as a result of non-contiguous allocation. But there is a clustering of transmit emissions that can lead to failing to meet the emission requirements. In general, the more concentrated into isolated clusters the transmit signal gets, the more uneven the emission in the frequency domain becomes. Currently, non-contiguous allocation with some limitation is allowed. This scheme is called “almost contiguous allocation.” Some of the motivation for this was that when some narrow subband(s) need to be reserved for some other users, for example for eMTC or NB-IoT UL, and the subband is in the middle of the channel, then allowing only contiguous allocation would limit the possible maximum frequency allocation to about one half of the total available. Almost contiguous allocation has the following attributes:

$$\frac{{N}_{RB \_ gap}}{{N}_{{RB}_{alloc}} + {N}_{RB \_ gap}} \leq 0.25$$

$${N}_{{RB}_{alloc}} + {N}_{RB \_ gap} > 106 RBs for 15 kHz SCS$$

$${N}_{{RB}_{alloc}} + {N}_{RB \_ gap} > 51 RBs for 30 kHz SCS$$

$${N}_{{RB}_{alloc}} + {N}_{RB \_ gap} > 24 RBs for 60 kHz SCS$$

Where N_{RB_alloc} is the total number of allocated RBs and N_{RB_gap} is the total number of unallocated RBs in the gaps, where each gap is bounded by the allocated RBs on both sides. In general, there is no limitation on the number of gaps or on the number of allocated clusters (which is one more than the number of gaps), or on the arrangement of allocated clusters other than the allocation granularity expressed as the RBG size. Currently, almost contiguous allocation on the uplink is only allowed in the FR1; it is not allowed in the FR2. The reason for this is that there is no need to reserve bandwidth for eMTC or NB-IoT in FR2, and in general, the analog beamforming restriction makes UL FDM multiplexing of different WTRUs less likely in FR2 than in FR1.

The applicable resource allocation type (type 0 or type 1) may be dynamically indicated in the UL grant, when both CP-OFDM and dynamic switching are configured by RRC. When dynamic switching is configured, one bit is included in DCI format 0_1 to indicate the resource allocation type applicable to the granted PUSCH. Otherwise, the resource allocation type itself is RRC configured for CP-OFDM. This allows a gNB to choose between maximum scheduling flexibility and DCI payload minimization. When dynamic switching is configured, the maximum of the type 0 and type 1 bit-width is used in DCI format 0_1 to make the payload size invariant, an additional bit is included in DCI format 0_1 as the switching flag.

### PUSCH Frequency-Hopping

Frequency hopping is supported for PUSCH transmissions only when frequency domain resource allocation type 1 is used. Frequency hopping is not supported when resource allocation type 0 is used since type 0 can already allocate non-contiguous RBs, even though the frequency diversity it can provide is bounded by the 25% limitation on the allowed “almost contiguous” maximum gap. The following two frequency hopping modes are supported: Intra-slot frequency hopping, applicable to both single-slot and multi-slot PUSCH transmission, and Inter-slot frequency hopping, applicable only to multi-slot PUSCH transmission

### Frequency Hopping for PUSCH Type A and for TB Processing Over Multiple Slots.

For PUSCH repetition Type A other than the PUSCH scheduled by RAR UL grant or fallbackRAR UL grant or by DCI format 0_0 with CRC scrambled by TC-RNTI and for TB processing over multiple slots, a WTRU may be configured for frequency hopping by the higher layer parameter frequencyHoppingDCI-0-2 in pusch-Config for PUSCH transmission scheduled by DCI format 0_2, and by frequencyHopping provided in pusch-Config for PUSCH transmission scheduled by a DCI format other than 0_2, and by frequencyHopping provided in configuredGrantConfig for configured PUSCH transmission.

For PUSCH repetition Type A scheduled by RAR UL grant or by DCI format 0_0 with CRC scrambled by TC-RNTI, a WTRU may be configured for frequency hopping by the frequency hopping flag information field of the RAR UL grant, and by the frequency hopping flag information field of DCI format 0_0 with CRC scrambled by TC-RNTI, respectively. One of two frequency hopping modes may be configured: Intra-slot frequency hopping, applicable to single slot and multi-slot configured PUSCH transmission, multi-slot PUSCH transmission scheduled by DCI format 0_1 or 0_2, each of multiple PUSCH transmissions scheduled by a DCI if the higher layer parameter pusch-TimeDomainAllocationListForMultiPUSCH is configured and each of multiple configured grant PUSCH transmissions in a configuration where the higher layer parameters cg-nrofSlots and cg-nrofPUSCH-InSlot are provided, and Inter-slot frequency hopping, applicable to multi-slot PUSCH transmission.

In case of resource allocation type 1, whether or not transform precoding is enabled for PUSCH transmission, the WTRU may perform PUSCH frequency hopping, if the frequency hopping field in a corresponding detected DCI format or in a random access response UL grant is set to 1, or if for a Type 1 PUSCH transmission with a configured grant the higher layer parameter frequencyHoppingOffset is provided, otherwise no PUSCH frequency hopping is performed.

For a PUSCH scheduled by RAR UL grant, fallbackRAR UL grant, or by DCI format 0_0 with CRC scrambled by TC-RNTI, frequency offsets may be obtained as follows: For a PUSCH transmission with frequency hopping scheduled by RAR UL grant or for a Msg3 PUSCH retransmission, the frequency offset for the second hop is given in Table 1. Msg3 PUSCH retransmissions, if any, of the transport block, are scheduled by a DCI format 0_0 with CRC scrambled by a TC-RNTI provided in the corresponding RAR message.

TABLE 1

| Number of PRBs in | Value of N_{UL, hop} | Frequency offset |
|---|---|---|
| initial UL BWP | Hopping Bits | for 2^{nd} hop |
| N_{BWP}^{size} < 50 | 0 | └N_{BWP}^{size}/2┘ |
| | 1 | └N_{BWP}^{size}/4┘ |
| N_{BWP}^{size} ≥ 50 | 00 | └N_{BWP}^{size}/2┘ |
| | 01 | └N_{BWP}^{size}/4┘ |
| | 10 | −└N_{BWP}^{size}/4┘ |
| | 11 | Reserved |

For a PUSCH scheduled by DCI format 0_0/0_1 or a PUSCH based on a Type2 configured UL grant activated by DCI format 0_0/0_1 and for resource allocation type 1, frequency offsets may be configured by higher layer parameter frequencyHoppingOffsetLists in pusch-Config. For a PUSCH scheduled by DCI format 0_2 or a PUSCH based on a Type2 configured UL grant activated by DCI format 0_2 and for resource allocation type 1, frequency offsets may be configured by higher the layer parameter frequencyHoppingOffsetListsDCI-0-2 in pusch-Config.

When the size of the active BWP is less than 50 PRBs, one of two higher layer configured offsets may be indicated in the UL grant, and when the size of the active BWP is equal to or greater than 50 PRBs, one of four higher layer configured offsets may be indicated in the UL grant. The parameters for the configured offsets are described below.

The field frequencyHopping applies to DCI format 0_0 and 0_1 for ‘pusch-RepTypeA’. The value intraSlot enables ‘Intra-slot frequency hopping’ and the value interSlot enables ‘Inter-slot frequency hopping’. If the field is absent, frequency hopping is not configured for ‘pusch-RepTypeA’.

The field frequencyHoppingDCI-0-1 indicates the frequency hopping scheme for DCI format 0_1 when pusch-RepTypeIndicatorDCI-0-1 is set to ‘pusch-RepTypeB’, The value interRepetition enables ‘Inter-repetition frequency hopping’, and the value interSlot enables ‘Inter-slot frequency hopping’. If the field is absent, frequency hopping is not configured for DCI format 0_1 for ‘pusch-Rep TypeB’.

The frequencyHoppingDCI-0-2 field indicates the frequency hopping scheme for DCI format 0_2. The value intraSlot enables ‘intra-slot frequency hopping’, and the value interRepetition enables ‘Inter-repetition frequency hopping’, and the value interSlot enables ‘Inter-slot frequency hopping’. When pusch-Rep TypeIndicatorDCI-0-2 is not set to ‘pusch-RepTypeB’, the frequency hopping scheme may be chosen between ‘intra-slot frequency hopping and ‘inter-slot frequency hopping’ if enabled. When pusch-RepTypeIndicatorDCI-0-2 is set to ‘pusch-RepTypeB’, the frequency hopping scheme may be chosen between ‘inter-repetition frequency hopping’ and ‘inter-slot frequency hopping’ if enabled. If the field is absent, frequency hopping is not configured for DCI format 0_2.

The frequencyHoppingOffsetLists, applies to DCI format 0_0 and DCI format 0_1, and the field frequencyHoppingOffsetListsDCI-0-2 applies to DCI format 0_2. These set of frequency hopping offsets may be used when frequency hopping is enabled for granted transmission (not msg3) and type 2 configured grant activation.

For PUSCH based on a Type 1 configured UL grant the frequency offset may be provided by the higher layer parameter frequencyHoppingOffset in rrc-ConfiguredUplinkGrant. The parameters for these configured offsets are described below.

The field frequencyHopping applies to configured grant for ‘pusch-RepTypeA’. The value intraSlot enables ‘Intra-slot frequency hopping’ and the value interSlot enables ‘Inter-slot frequency hopping’. If the field is absent, frequency hopping is not configured. The field frequencyHoppingOffset, may be used when frequency hopping is enabled.

The field frequencyHoppingPUSCH-Rep TypeB indicates the frequency hopping scheme for Type 1 CG when pusch-Rep TypeIndicator is set to ‘pusch-RepTypeB’. The value interRepetition enables ‘Inter-repetition frequency hopping’, and the value interSlot enables ‘Inter-slot frequency hopping’. If the field is absent, the frequency hopping is not enabled for Type 1 CG.

For a MsgA PUSCH, the frequency offset may be provided by the higher layer parameter. For a PUSCH transmission with frequency hopping in a slot, when indicated by msgA-intraSlotFrequencyHopping for the active UL BWP, the frequency offset for the second hop may be determined as described in Table 1 using msgA-HoppingBits instead of N_{UL,hop}. If guardPeriodMsgA-PUSCH is provided, a first symbol of the second hop is separated by guardPeriodMsgA-PUSCH symbols from the end of a last symbol of the first hop; otherwise, there is no time separation of the PUSCH transmission before and after frequency hopping. If a WTRU is provided with useInterlacePUCCH-PUSCH in BWP-UplinkCommon, the WTRU may transmit PUSCH without frequency hopping. A PUSCH transmission may use a same spatial filter as an associated PRACH transmission. The parameters for a MsgA PUSCH are provided below.

The parameter msgA-IntraSlotFrequencyHopping indicates intra-slot frequency hopping per PUSCH occasion, and msgA-HoppingBits is a value of hopping bits to indicate which frequency offset to be used for second hop.

In case of intra-slot frequency hopping, the starting RB in each hop is given by:

$${RB}_{start} = \{ \begin{matrix}{RB}_{start} & i = 0 \\ ( {RB}_{start} + {RB}_{offset} ) mod {N}_{BWP}^{size} & i = 1\end{matrix}$$

Where i=0 and i=1 are the first hop and the second hop respectively, and RBₛₜₐᵣₜ is the starting RB within the UL BWP, as calculated from the resource block assignment information of resource allocation type 1 or as calculated from the resource assignment for MsgA PUSCH, and RB_{offset} is the frequency offset in RBs between the two frequency hops. The number of symbols in the first hop is given by

$$⌊ {N}_{symb}^{PUSCH , s} / 2 ⌋ ,$$

the number of symbols in the second hop is given by

$${N}_{symb}^{PUSCH , s} - ⌊ {N}_{symb}^{PUSCH , s} / 2 ⌋ ,$$

where N_{symb}^{PUSCH,s} is the length of the PUSCH transmission in OFDM symbols in one slot.

In case of inter-slot frequency hopping and when PUSCH-DMRS-Bundling (the same or coherent DMRS being sent over multiple time slots for coverage enhancement) is not enabled, or for inter-slot frequency hopping for a PUSCH scheduled by RAR UL grant or DCI format 0_0 with CRC scrambled by TC-RNTI, the starting RB during slot ng is given by:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix}$$

Where nₛ^{μ}is the current slot number within a system radio frame, where a multi-slot PUSCH transmission may take place, RBₛₜₐᵣₜ is the starting RB within the UL BWP, as calculated from the resource block assignment information of resource allocation type 1 and RB_{offset} is the frequency offset in RBs between the two frequency hops.

In case of inter-slot frequency hopping and when PUSCH-DMRS-Bundling is enabled, and when a PUSCH is not scheduled by RAR UL grant or DCI format 0_0 with CRC scrambled by TC-RNTI, the starting RB during slot nₛ^{μ} is given by:

$${RB}_{start} ( {n}_{s}^{μ} ) = \{ \begin{matrix}{RB}_{start} & ⌊ \frac{{n}_{s}^{μ}}{{N}_{FH}} ⌋ mod 2 = 0 \\ ( {RB}_{start} + {RB}_{offset} ) mod {N}_{BWP}^{size} & ⌊ \frac{{n}_{s}^{μ}}{{N}_{FH}} ⌋ mod 2 = 1\end{matrix}$$

Where nₛ^{μ} is the current slot number within a system radio frame, N_{FH} is the value of the higher layer parameter PUSCH-Frequencyhopping-Interval, RBₛₜₐᵣₜ is the starting RB within the UL BWP, as calculated from the resource block assignment information of resource allocation type 1 and RB_{offset} is the frequency offset in RBs between the two frequency hops.

The parameter pusch-DMRS-Bundling indicates whether DMRS bundling and time domain window for PUSCH are jointly enabled, and pusch-FrequencyHoppingInterval configures the number of consecutive slots for the WTRU to perform inter-slot frequency hopping with inter-slot bundling for PUSCH. When both inter-frequency hopping and DMRS bundling are enabled for PUSCH repetitions, the WTRU may be expected to be configured with at least one pusch-FrequencyHoppingInterval-r17 and pusch-TimeDomainWindowLength-r17. This parameter is shared for both DG-PUSCH and CG-PUSCH. When DMRS bundling for PUSCH is enabled by pusch-DMRS-Bundling-r17, PUSCH frequency hopping interval is only determined by the configuration of PUSCH hopping interval if PUSCH hopping interval is configured. If the field is absent, the number of consecutive slots for the UE to perform inter-slot PUSCH frequency hopping is indicated by pusch-TimeDomainWindowLength-r17. For unpaired spectrum, the WTRU may not be expected to be configured the value of s6, s8, s12, s14 and s16.

The parameter pusch-TimeDomainWindowLength configures the length of a nominal time domain window in number of consecutive slots for DMRS bundling for PUSCH. The value shall not exceed the maximum duration for DMRS bundling for PUSCH. For PUSCH repetition type A/B, if this field is absent, the WTRU may apply the default value that is the minimum value in the unit of consecutive slots of the time duration for the transmission of all PUSCH repetitions and the maximum duration for DMRS bundling for PUSCH. For TBoMS, if this field is absent, the UE may apply the default value that is the minimum value in the unit of consecutive slots of the duration of TBoMS transmission (including repetition of TBoMS) and the maximum duration for DMRS bundling for PUSCH.

The parameter pusch-WindowRestart indicates whether a WTRU bundles PUSCH DMRS remaining in a nominal time domain window after event(s) triggered by DCI or MAC CE that violate power consistency and phase continuity requirements is enabled. Events, which are triggered by DCI or MAC CE, but do not require WTRU capability to resume maintaining power consistency and/or phase continuity are excluded.

### Frequency Hopping for PUSCH Repetition Type B.

For PUSCH repetition Type B, a WTRU may be configured for frequency hopping by the higher layer parameter frequencyHoppingDCI-0-2 in pusch-Config for PUSCH transmission scheduled by DCI format 0_2, by frequencyHoppingDCI-0-1 provided in pusch-Config for PUSCH transmission scheduled by DCI format 0_1, and by frequencyHoppingPUSCH-Rep TypeB provided in rrc-ConfiguredUplinkGrant for Type 1 configured PUSCH transmission. The frequency hopping mode for Type 2 configured PUSCH transmission follows the configuration of the activating DCI format. One of two frequency hopping modes can be configured: Inter-repetition frequency hopping and Inter-slot frequency hopping.

In a case of resource allocation type 1, whether or not transform precoding is enabled for PUSCH transmission, the WTRU may perform PUSCH frequency hopping, if the frequency hopping field in a corresponding detected DCI format is set to 1, or if for a Type 1 PUSCH transmission with a configured grant the higher layer parameter frequencyHoppingPUSCH-RepTypeB is provided, otherwise no PUSCH frequency hopping is performed. When frequency hopping is enabled for PUSCH, RE mapping may be defined.

For a PUSCH scheduled by DCI format 0_1 or a PUSCH based on a Type 2 configured UL grant activated by DCI format 0_1 and for resource allocation type 1, frequency offsets may be configured by higher layer parameter frequencyHoppingOffsetLists in pusch-Config. For a PUSCH scheduled by DCI format 0_2 or a PUSCH based on a Type 2 configured UL grant activated by DCI format 0_2 and for resource allocation type 1, frequency offsets may be configured by higher layer parameter frequencyHoppingOffsetListsDCI-0-2 in pusch-Config.

When the size of the active BWP is less than 50 PRBs, one of two higher layer configured offsets may be indicated in the UL grant, and when the size of the active BWP is equal to or greater than 50 PRBs, one of four higher layer configured offsets may be indicated in the UL grant.

In case of inter-repetition frequency hopping, the starting RB for an actual repetition within the n-th nominal repetition is given by:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix}$$

Where RBₛₜₐᵣₜ is the starting RB within the UL BWP, as calculated from the resource block assignment information of resource allocation type 1 and RB_{offset} is the frequency offset in RBs between the two frequency hops. In case of inter-slot frequency hopping, the starting RB during slot n follows that of inter-slot frequency hopping for PUSCH Repetition Type A.

Frequency diversity may be obtained in an uplink, for example a PUSCH, by avoiding the use of frequency resources that overlap with an interfering signal such as RADAR operating in the bandwidth. While the description that follows will refer to RADAR as the source of an interfering signal, it should be appreciated that the following description may apply to any type of interfering or interference signal.

### Dynamic Triggering of PUSCH Skip-PRB Frequency Hopping for RADAR Coexistence.

To obtain frequency diversity in the uplink and mitigate interference, frequency hopping may be used. Uplink frequency hopping can be dynamically controlled using a bit or bits in the DCI scheduling the transmission. When frequency hopping is enabled, the data in the first set of OFDM symbols in the slot may be transmitted on the resource block as indicated by the scheduling grant. In the remaining OFDM symbols and/or slots, data are transmitted on a different set of resource blocks given by a configurable offset from the first set. Frequency hopping is supported for PUSCH transmissions when frequency domain resource allocation type 1 is used, which supports frequency-contiguous allocations.

In addition, one way to reduce the interference to RADAR, for example, is to avoid the use of frequency resources that overlap the bandwidth the RADAR is actively transmitting or listening for the return pulses. This may be known as ‘PRB blanking’. It should be understood that PRB blanking may be applied with or without frequency hopping. Based on the estimates of RADAR rotation timing estimates and the power spectral density, the time-frequency interference region is evaluated and a 5G scheduler, for example, avoids allocating the resource blocks for uplink or downlink traffic in the region. To avoid PUSCH frequency hopping transmission to step into the RADAR bandwidth, a frequency hopping mechanism is proposed to hop around the RADAR bandwidth and mitigate the interference to and from the RADAR, and herein may also be referred to as skip-PRB frequency hopping.

To coexist with a RADAR, a network node, for example a gNB, may configure PUSCH skip-PRB frequency hopping for WTRUs that will or may incur interference to and from the RADAR. The configuration of PUSCH skip-PRB frequency hopping may be triggered for a WTRU when the RADAR interference exceeds a threshold. The threshold may be preconfigured, determined dynamically or provided by an external entity. Different thresholds may be defined and selected by the gNB. For example, a set of thresholds may be defined based on the MCS or modulation order. The gNB may then select the appropriate threshold based on the MCS or modulation order used for the PUSCH. And in other examples, the threshold may be selected based on characteristics of the data, characteristics of the service and/or characteristics of the WTRU, for example, the QoS of the data being transmitted on the PUSCH, the service being provided to the WTRU, and the WTRU type.

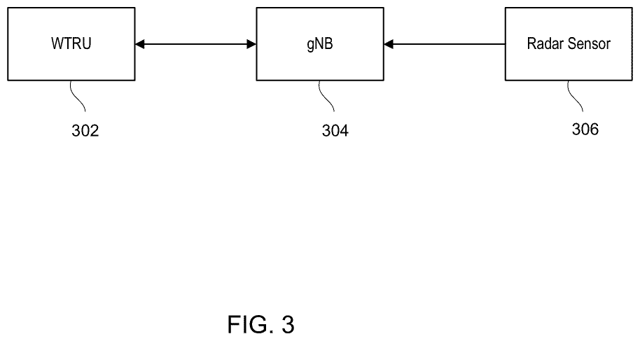

FIG. 3 is an exemplary system for sensing RADAR information. In example embodiments, a gNB determines PRBs to be excluded from PUSCH frequency hopping according to characteristics of a measured signal. The measured signal may be, for example a RADAR. The characteristics of the measured interference signal may include one or more of: a carrier frequency, bandwidth, periodicity, dwell time, Angle of Arrival (AoA), and Power Spectral Density (PSD). In one example, RADAR AoA information may be used by gNB 304 to determine the spatial direction of the RADAR interference in the cell, and gNB 304 may then configure PUSCH skip-PRB frequency hopping for WTRU 302 located in areas of the cell that would incur RADAR interference exceeding a threshold. Alternatively, gNB 304 may perform measurements to determine the information characterizing the operation of the RADAR. And in yet another alternative example, measurements performed by gNB 304 may be used in combination with information provided by external entity 306 to characterize the operation of the RADAR.

The gNB 304, alone or in combination with WTRU 302 may determine whether the measured interference signal is equal to or greater than a threshold value. The threshold value may be preconfigured, determined dynamically, provided by the network element (gNB), or provided by another network element (not shown). While WTRU 304 is illustrated in FIG. 3, it should be appreciated by those skilled in the art that gNB 304 may determine an interference level that may be seen by more than one WTRU and WTRU 302 may be viewed as a plurality of WTRUs operating within a cell served by gNB 304.

WTRU 302 may include a receiver configured to: receive from a network element, for example gNB 304, PRB exclusion information, the PRB exclusion information identifying PRBs excluded from Physical Uplink Shared Channel (PUSCH) frequency hopping transmission. For example, gNB 304, with information provided by external entity 306, performing its own measurements, receiving information from WTRU 302 or with a combination information by external entity 306, its own measurements, and information received from WTRU 302, taken alone or in any combination, determines PRBs to be excluded from the PUSCH transmission and provides this information to WTRU 302. The receiver in WTRU 304 may be configured to receive from the network element (gNB 304) a signal to trigger PUSCH frequency hopping with PRB exclusion. WTRU 302 may include a processor configured to: store the PRB exclusion information and retrieve the most recently stored the PRB exclusion when the signal to trigger the PUSCH frequency hopping with PRB exclusion is received. WTRU 304 may also include a transmitter configured to transmit the frequency hopping PUSCH with PBR exclusion.

A serving cell (gNB 304) may use a MAC-CE, group common signaling or higher layer signaling to inform RRC connected WTRUs (302) about the PRBs to be excluded from PUSCH frequency hopping transmission to facilitate PUSCH skip-PRB frequency hopping where the skip-PRB is one or more PRBs that are avoided in the PUSCH transmission.

In other words, the PRB exclusion information to support skip-PBR frequency hopping may be transmitted to WTRU 302 via a MAC-CE command, a RRC signal, a RAR signal or by group common signaling. The PRB exclusion information may be provided in one or more PUSCH Hopping Exclusion PRB range fields or by a PUSCH Hopping Exclusion Resource Block Group (RBG) bitmap. In an embodiment, the PRB exclusion information may be provided by a PUSCH PRB exclusion MAC CE. As an example, PUSCH PRB Exclusion MAC CE may include:
R/F/LCID (1 byte) where R is a reserved bit, which may be set to 0, F is the format field (1 bit), and LCID is a Logical Channel ID (6 bits);
eLCID (1 or 2 bytes, 1 byte if LCID 33, 2 bytes if LCI=34), which is an Extended Logic Channel ID, and where a unique eLCID value may be used to identify the PUSCH skip-PRB frequency hopping command;
L (1 or 2 bytes, 1 byte if =0, 2 bytes if F=1) where the length field indicating the length of the corresponding MAC SDU or variable sized MAC-CE in bytes; and
PUSCH Hopping Exclusion PRB Range (2 bytes). This field indicates the PRB range that the PUSCH frequency hopping will skip around. The PRB range may be specified using the resource indication value (RIV). The value of all 0s restores PUSCH frequency hopping transmission to normal operation. In an example embodiment, multiple ‘PUSCH Hopping Exclusion PRB Range’ fields can be included to accommodate non-contiguous exclusion PRB ranges.

In another example embodiment, a ‘PUSCH Hopping Exclusion RBG Bitmap’ can be provided in the MAC CE to indicate the RBGs to be excluded in the PUSCH frequency hopping process (a bit of 1 indicates that the specific RBGs are excluded during PUSCH frequency hopping, and a bit of 0 indicates otherwise).

It is noted that even in the case when no PRBs are excluded, the skip-PRB frequency hopping algorithm described accounts for the number of contiguous RBs (LRBs) for PUSCH transmission in a more general manner and is hence more robust than a baseline frequency hopping algorithm.

The network may use dedicated DCI signaling to dynamically indicate PUSCH skip-PRB frequency hopping by introducing a new ‘skip-PRB hopping’ flag (e.g., in DCI format 0_0, 0_1, and 0_2) to indicate whether the ‘frequency hopping’ field is triggering the baseline PUSCH frequency hopping algorithm or the skip-PRB frequency hopping algorithm. When the ‘skip-PRB hopping’ flag is absent or set to 0, the ‘frequency hopping’ field (present only for resource allocation type 1) may be interpreted the same way as a baseline frequency hopping algorithm. On the other hand, when the ‘skip-PRB hopping’ flag is set to 1, ‘frequency hopping’=1 indicates skip-PRB frequency hopping may be applied. Thus, if the field ‘frequency hopping’ is set 0 the ‘skip-PRB hopping’ flag can be ignored if it is present.

In addition, for WTRUs trying to perform random access, the network can use the random-access response (RAR) to trigger PUSCH skip-PRB frequency hopping in the initial UL BWP and provide the information about the PRBs to be excluded from PUSCH frequency hopping.

Upon the receiving the DCI signaling or RAR to trigger PUSCH skip-PRB frequency hopping, a WTRU may perform frequency hopping as follows: retrieve the latest information with respect to the ‘PUSCH Hopping Exclusion PRB Range’ received from the network; determine the reduced UL BWP (denoted as UL BWP′) as the original UL BWP subtracting the excluded PRBs (as specified by ‘PUSCH Hopping Exclusion PRB Range’) that fall into this UL BWP, where the excluded PBRs for a UL BWP′ may be located inside the UL BWP or on the edge of the UL BWP; determine the number of contiguous RBs (L_{RBs}) for PUSCH transmission based on the received uplink grant (based on frequency domain resource allocation type 1); determine the number of feasible allocations N_{BWP′}^{alloc_L} within the UL BWP′, with L_{RBs} being the size of the contiguous RBs of a feasible allocation, where the N_{BWP′}^{alloc_L} feasible allocations are labeled k=0 . . . N_{BWP′}^{alloc_L}−1 based on the ascending order of the starting RB of each feasible allocation. For the k^{th} feasible allocation, the starting RB index is labelled RB_{k_start}. In the absence of PRB exclusion, the number of feasible (L_{RBs} contiguous RBs) allocations within a UL BWP of size (N_{BWP}^{size}) is simply

$${N}_{{BWP}^{′}}^{alloc\_L} = {N}_{BWP}^{size} - {L}_{RBs} + 1 ,$$

and determine the starting RB for each hop as follows:

For frequency hopping for PUSCH repetition Type A and for TB processing over multiple slots, in case of intra-slot skip-PRB frequency hopping, the starting RB in each hop is equal to RB_{k_start}, Where k_start is given as follows:

$$k\_start = \{ \begin{matrix}{k}_{start} & i = 0 \\ ( {k}_{start} + {k}_{offset} ) mod {N}_{{BWP}^{′}}^{alloc \_ L} & i = 1\end{matrix}$$

Where kₛₜₐᵣₜ is the feasible hopping start index k, determined from the RB assignment information of resource allocation type 1, k_{offset} is the offset in index k between the two frequency hops. As an example,

$${k}_{offset} = min ( {RB}_{offset} , ⌊ {N}_{{BWP}^{′}}^{alloc\_L} / 2 ⌋ ) ,$$

where RB_{offset} is frequency hopping offset configured by the higher layers, and i=0 and i=1 are the first hop and the second hop respectively.

In case of inter-slot skip-PRB frequency hopping, when PUSCH-DMRS-Bundling is not enabled, or for inter-slot frequency hopping for a PUSCH scheduled by RAR UL grant or DCI format 0_0 with CRC scrambled by TC-RNTI (Msg3 PUSCH retransmission), the starting RB during slot nₛ^{μ} is equal to RB_{k_start}, where k_start is given as follows:

$$k\_start ( {n}_{s}^{μ} ) = \{ \begin{matrix}{k}_{start} & {n}_{s}^{μ} mod 2 = 0 \\ ( {k}_{start} + {k}_{offset} ) mod {N}_{{BWP}^{′}}^{alloc\_L} & {n}_{s}^{μ} mod 2 = 1\end{matrix}$$

Where kₛₜₐᵣₜ is the feasible hopping start index k, determined from the RB assignment information of resource allocation type 1, k_{offset} is the offset in index k between the two frequency hops, nₛ^{μ} is the current slot number within a system radio frame a multi-slot PUSCH transmission can take place. As an example, k_{offset}=RB_{offset}, and RB_{offset} is determined by

Table 2.

TABLE 2

| Number of PRBs in | Value of N_{UL, hop} | Frequency offset |
|---|---|---|
| initial UL BWP | Hopping Bits | for 2^{nd} hop |
| N_{BWP}^{size} < 50 | 0 | └N_{BWP′}^{alloc}^{_{—}}^{L}/2┘ |
| | 1 | └N_{BWP′}^{alloc}^{_{—}}^{L}/4┘ |
| N_{BWP}^{size} ≥ 50 | 00 | └N_{BWP′}^{alloc}^{_{—}}^{L}/2┘ |
| | 01 | └N_{BWP′}^{alloc}^{_{—}}^{L}/4┘ |
| | 10 | −└N_{BWP′}^{alloc}^{_{—}}^{L}/4┘ |
| | 11 | Reserved |

When PUSCH-DMRS-Bundling is enabled, and when a PUSCH is not scheduled by RAR UL grant or DCI format 0_0 with CRC scrambled by TC-RNTI, the starting RB during slot nₛ^{μ} is equal to RB_{k_start}, where k_start is given as follows:

$$k\_start ( {n}_{s}^{μ} ) = \{ \begin{matrix}{k}_{start} & ⌊ \frac{{n}_{s}^{μ}}{{N}_{FH}} ⌋ mod 2 = 0 \\ ( {k}_{start} + {k}_{offset} ) mod {N}_{{BWP}^{′}}^{alloc\_L} & ⌊ \frac{{n}_{s}^{μ}}{{N}_{FH}} ⌋ mod 2 = 1\end{matrix} ,$$

Where, Kₛₜₐᵣₜ is the feasible hopping start index k, determined from the RB assignment information of resource allocation type 1, k_{offset} is the offset in index k between the two frequency hops. As an example, k_{offset}=min(RB_{offset},└N_{BWP′}^{alloc-L}/2┘), where RB_{offset} is a frequency hopping offset configured by the higher layers. And nₛ^{μ} is the current slot number within a system radio frame, N_{FH} is the value of the higher layer parameter PUSCH-Frequencyhopping-Interval.

For frequency hopping for PUSCH repetition Type B, in the case of inter-repetition skip-PRB frequency hopping, the starting RB for an actual repetition within the n-th nominal repetition is equal to RB_{k_start}, where k_start is given as follows:

$$k\_start ( n ) = \{ \begin{matrix}{k}_{start} & n mod 2 = 0 \\ ( {k}_{start} + {k}_{offset} ) mod {N}_{{BWP}^{′}}^{alloc\_L} & n mod 2 = 1\end{matrix}$$

Where kₛₜₐᵣₜ is the feasible hopping start index k, determined from the RB assignment information of resource allocation type 1, k_{offset} is the frequency offset in index k between the two frequency hops. As an example,

$${k}_{offset} = min ( {RB}_{offset} , ⌊ {N}_{{BWP}^{′}}^{alloc\_L} / 2 ⌋ ) ,$$

where RB_{offset} is frequency hopping offset configured by the higher layers.

In case of inter-slot skip-PRB frequency hopping, the starting RB during slot n follows that of inter-slot skip-PRB frequency hopping for PUSCH Repetition Type A.

A WTRU may inform the network of its capability to support PUSCH skip-PRB frequency hopping, as exemplified by the following information message.

| | | | FDD − TDD | FR1 − FR2 |
|---|---|---|---|---|
| Definitions for parameters | Per | M | DIFF | DIFF |
| puschSkipPrbFrequencyHopping | UE | No | No | No |
| Indicates whether the WTRU | | | | |
| supports PUSCH skip-PRB | | | | |
| frequency hopping. | | | | |

WTRU 302 may be configured to: determine a reduced active Uplink (UL) Bandwidth Part (BWP) according to the PRB exclusion information; determine a number of contiguous Resource Block (RB) allocations based on a received uplink grant allocation; determine a number of feasible allocations with contiguous RBs within the reduced active UL BWP; and determine a starting RB of a feasible allocation for each of a plurality of frequency hops.

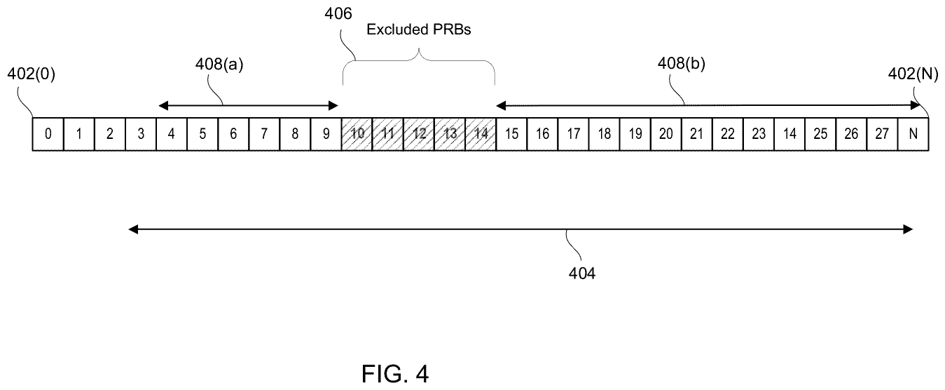

FIG. 4 is an exemplary illustration of PRB exclusion from an active BWP. FIG. 4 illustrates PRBs 402(1) to 402(N). The number and pattern of PRB (402(1)-402(N) shown are merely for illustrative purpose and should not be viewed as limiting. At least from the description in preceding paragraphs, it should be understood that the number of PRBs may differ according the bandwidth and SCS.

As illustrated in FIG. 4, the active BWP 404 includes PRBs 402(3)-402(N). In this example, the excluded PRBs 406 include PRBs 402(10)-402(14). The PRB exclusion information indicating PRBs 406 may be provided in one or more PUSCH Hopping Exclusion PRB Range fields, or by a PUSCH Hopping Exclusion Resource Block Group (RBG) bitmap. Excluded PRBs 406 are shown simply for illustrative purpose. One skilled in the art should appreciate that excluded PRBs 406 represent PRBs experiencing interference from one or more high-power narrowband interferer(s) or PRBs that may interfere with RADAR, for example, excluded PRBs 406 may include PRBs in any location of the active BWP experiencing interference.

A network element, for example, gNB 304, may determine the excluded PRBs 406 based on information provided an external entity, for example external entity 306, characterizing the operation of a RADAR, based on information derived by performing its own measurements or based on a combination information by external entity 306 and its own measurements. The network entity (gNB 304) may notify a WTRU, for example WTRU 302, of the excluded PRBs. As described above, this information may be included in a MAC-CE, RRC signal, RAR signal, or a group common signal. The WTRU may store the PRB exclusion information. The network, for example gNB 304, may dynamically trigger PUSCH frequency hopping (skip-PRB hopping) transmission with PRB exclusion via DCI signaling.

Upon receiving the DCI signaling to trigger the PUSCH frequency hopping transmission with PRB exclusion, the WTRU may retrieve the latest or most recent PRB exclusion information and determine a reduced active UL active BWP. The reduced active UL BWP may be determined by subtracting excluded PRBs (406) from the original active UL BWP 404 according to the PRB exclusion information which may be indicated by the PUSCH Hopping Exclusion PRB range fields or by the PUSCH Hopping Exclusion Resource Block Group (RBG) bitmap.

For example, the WTRU may determine reduced active UL BWP to 408a and 408b. The WTRU may determine a number of contiguous RBs(L_{RBs}) for PUSCH transmission based on a received uplink grant allocation, for example in 408a there are 7 available RBs [3.9] (PRBs 408(3)-402(9). If L_{RBs}=5, then

$${N}_{{BWP}^{′}}^{alloc\_L} ( a ) = 7 - 5 + 1 = 3 ,$$

for example [408(3)-480(7)], [408(4)-480(8)], and [408(5)-480(9)].

Similarly, in 408 (b) there are N−15+1 available contiguous RBs [15.N], (PRBs 402(15)-402(N)). In 408b for allocation size

$${L}_{RBs} = 5 , {N}_{{BWP}^{′}}^{alloc\_L} ( b ) = ( N - 15 + 1 ) - 5 + 1 = N - 18.$$

If we assume N=28, then

$${N}_{{BWP}^{′}}^{alloc\_L} ( b ) = 28 - 18 = 10.$$

The WTRU may determine a number of feasible allocations (N_{BWP′}^{alloc_L}) within the reduced active UL BWP, with L_{RBs} being contiguous RBs of each feasible allocation. Continuing the above example, the number of feasible allocations

$${N}_{{BWP}^{′}}^{alloc\_L} = {N}_{{BWP}^{′}}^{alloc\_L} ( a ) + {N}_{{BWP}^{′}}^{alloc\_L} ( b ) = N - 18 + 3 = N - 15.$$

If we assume N=28, then

$${N}_{{BWP}^{′}}^{alloc\_L} = 28 - 15 = 10 + 3 = 13.$$

The N_{BWP′}^{alloc_L} feasible allocations are labeled k=0 . . . N_{BWP′}^{alloc_L}−1 based on the ascending order of the starting RB of each feasible allocation of L_{RBs} contiguous RBs. The WTRU may determine a starting RB of the feasible allocation for each of a plurality of frequency hops (not shown).

Determining the starting RB for each hop, RB_{k_start}, where k_start is given as follows:

$$k\_start ( {n}_{hop} ) = \{ \begin{matrix}{k}_{start} & {n}_{hop} mod 2 = 0 \\ ( {k}_{start} + {k}_{offset} ) mod {N}_{{BWP}^{′}}^{alloc\_L} & {n}_{hop} mod 2 = 1\end{matrix}$$

Where kₛₜₐᵣₜ is the feasible hopping start index k, determined from the RB assignment information of resource allocation type 1, k_{offset} is the offset in index k between the two frequency hops. In an

$${k}_{offset} = min ( {RB}_{offset} , ⌊ {N}_{{BWP}^{′}}^{alloc\_L} / 2 ⌋ ) ,$$

and RB_{offset} is frequency hopping offset configured by the higher layers or by

Table 2, and

nₕₒₚ represents the hopping number starting from 0. For example, k=0 . . . 12; RBₖ₀=3, RBₖ₁=4, RBₖ₂=5; RBₖ₃=15, RBₖ₄=16, RBₖ₅=17, RBₖ₆=18, RBₖ₇=19, RBₖ₈=20, RBₖ₉=21, RBₖ₁₀=22, RBₖ₁₁=23, RBₖ₁₂=24. k_{offset}=└13/2┘=6. If RB_{k_start}=3 based on uplink grant, then

$${k}_{start} = 0 , ( {k}_{start} + {k}_{offset} ) mod {N}_{{BWP}^{′}}^{alloc\_L} = ( 0 + 6 ) mod 13 = 6.$$

Thus, for this example allocation of L_{RBs}=5 contiguous RBs, PUSCH transmission may be hopped between feasible allocations [408(3), 408(4), 408(5), 408(6), 408(7)] and [408(18), 408(19), 408(20), 408(21), 408(22)]. If RB_{k_start}=22 based on uplink grant, then

$${k}_{start} = 10 , ( {k}_{start} + {k}_{offset} ) mod {N}_{{BWP}^{′}}^{alloc\_L} = ( 10 + 6 ) mod 13 = 3.$$

For this allocation, PUSCH transmission is hopped between [408(22), 408(23), 408(24), 408(25), 408(26)] and [408(15), 408(16), 408(17), 408(18), 408(19)].

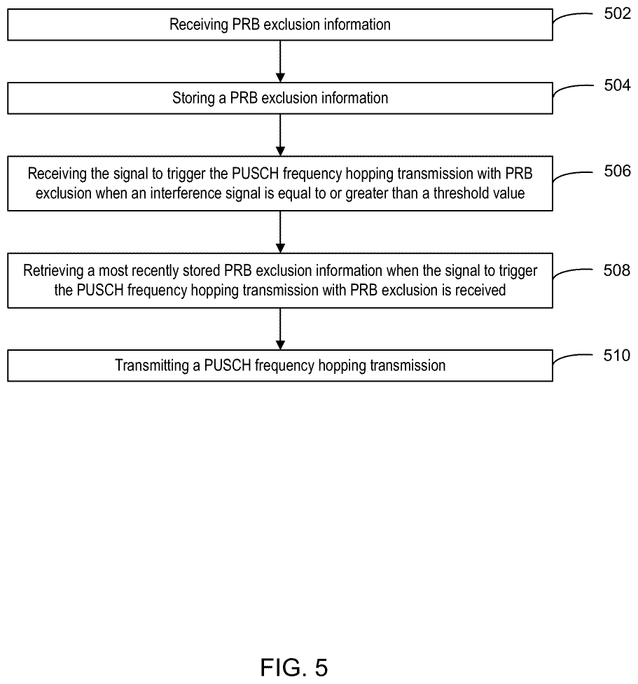

FIG. 5 is a flow diagram showing an exemplary process according to embodiments disclosed herein. Illustrated in FIG. 5 is a process performed at a WTRU. At 502, a WTRU receives PRB exclusion information. The PRB exclusion may include information indicating the PRBs that are excluded from a PUSCH transmission, specifically a frequency hopping PUSCH transmission. The PRB exclusion information may be received a MAC-CE, RRC signal, RAR signal, or group common signaling. The PRB exclusion may be provided in one or more PUSCH Hopping Exclusion PRB Range fields, or a PUSCH Hopping Exclusion Resource Block Group (RBG) bitmap. The WTRU stores the PRB exclusion information at 504. At 506, the WTRU receives a signal to trigger the PUSCH frequency hopping transmission with PRB exclusion, for example, when an interference signal is equal or greater than a threshold value. In alternative embodiments, threshold value may be preconfigured, determined dynamically, or provided by a network element. When the WTRU receives the signal to trigger PUSCH transmission, at 508 the WTRU retrieves the most recently stored PRB exclusion information. At 510, the WTRU transmits the frequency hopping PUSCH transmission with PRB exclusion.

In an example embodiment, the process may include: determining a reduced active Uplink (UL) Bandwidth Part (BWP) according to the information indicating the PRB exclusion, where the reduced active UL BWP is determined by subtracting excluded PRBs from an original active UL BWP according to the information indicating the PRB exclusion; determining a number of contiguous Resource Block (RB) allocations based on a received uplink grant allocation; determining a number of feasible allocations with contiguous RBs within the reduced active UL BWP; and determining a starting RB for each of a plurality of frequency hops.

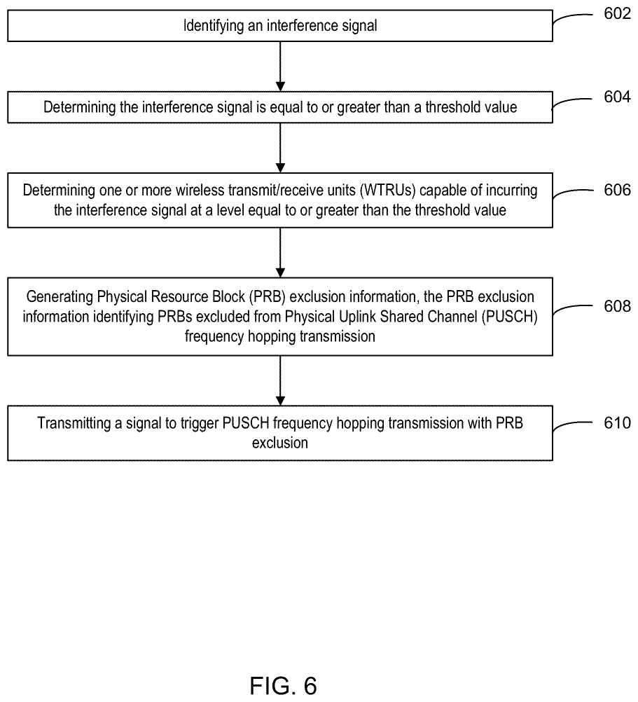

FIG. 6 is a flow diagram showing an exemplary process according to embodiments disclosed herein. Illustrated in FIG. 6 is a process performed at a network element, for example a gNB. At 602 the network element determines an interference signal. In an example embodiment, the network element determines characteristics of the interference signal. In a case where the interference signal is RADAR, the characteristics of the interference may include one or more of: carrier frequency, bandwidth, periodicity, dwell time, AoA, and Power Spectral Density (PSD). The network element, at 604 determines the interference signal is equal to or greater than a threshold value, and at 606, the network element determines one or more WTRUs capable of incurring the interference at a level equal to or greater than the threshold value. The threshold value may be preconfigured, determined dynamically, provided by the network element, or provided by another network element. At 608, the network element generates PRB exclusion information, the PRB exclusion information identifying PRBs excluded from a PUSCH transmission where the PUSCH transmission is PUSCH frequency hopping transmission. At 610, the network transmits a signal to trigger the PUSCH transmission when the interference is equal to or greater than a threshold value.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of triggering Physical Uplink Shared Channel (PUSCH) frequency hopping transmission implemented by a wireless transmit/receive unit (WTRU), the method comprising:
receiving Physical Resource Block (PRB) exclusion information, the PRB exclusion information identifying PRBs excluded from the PUSCH frequency hopping transmission;
storing the PRB exclusion information;
receiving a signal to trigger the PUSCH frequency hopping transmission with PRB exclusion when an interference signal is equal to or greater than a threshold value;
retrieving a most recently stored PRB exclusion information when the signal to trigger the PUSCH frequency hopping transmission with PRB exclusion is received; and
transmitting the PUSCH frequency hopping transmission with PRB exclusion.

2. The method according to claim 1, further comprising receiving the PRB exclusion information in Medium Access Control (MAC)-Control Element (CE), group common signaling, a Radio Resource Control (RRC) signal, or a Random Access Response (RAR) signal.

3. The method according to claim 2, wherein the PRB exclusion information is provided in one or more PUSCH Hopping Exclusion PRB Range fields, or a PUSCH Hopping Exclusion Resource Block Group (RBG) bitmap.

4. The method according to claim 1, further comprising:
determining a reduced active Uplink (UL) Bandwidth Part (BWP) according to the PRB exclusion information;
determining a number of contiguous Resource Block (RB) allocations based on a received uplink grant allocation;
determining a number of feasible allocations with contiguous RBs within the reduced active UL BWP; and
determining a starting RB for each of a plurality of frequency hops.

5. The method according to claim 4, wherein the reduced active UL BWP is determined by subtracting excluded PRBs from an original active UL BWP according to the PRB exclusion information.

6. The method according to claim 1, wherein the threshold value is preconfigured, determined dynamically, or provided by a network element.

7. A wireless transmit/receive unit (WTRU) comprising:
a receiver configured to:
receive, from a network element, Physical Resource Block (PRB) exclusion information, the PRB exclusion information identifying PRBs excluded from a Physical Uplink Shared Channel (PUSCH) frequency hopping transmission; and
receive, from the network element, a signal to trigger PUSCH frequency hopping transmission with PRB exclusion;
a processor configured to;
store the received the PRB exclusion information; and
retrieve a most recently stored PRB exclusion information when the signal to trigger the PUSCH frequency hopping with PRB exclusion is received; and
a transmitter configured to transmit a frequency hopping PUSCH signal with PRB exclusion according to the retrieved PBR exclusion information.

8. The WTRU according to claim 7, wherein the PRB exclusion information is included in a Medium Access Control (MAC)-Control Element (CE), common group signaling, a Radio Resource Control (RRC) signal, or a Random Access Response (RAR) signal.

9. The WTRU according to claim 8, wherein the PRB exclusion information is provided in one or more PUSCH Hopping Exclusion PRB Range fields, or by a PUSCH Hopping Exclusion Resource Block Group (RBG) bitmap.

10. The WTRU according to claim 8, wherein the processor is further configured to:
determine a reduced active Uplink (UL) Bandwidth Part (BWP) according to the PRB exclusion information;
determine a number of contiguous Resource Block (RB) allocations based on a received uplink grant allocation;
determine a number of feasible allocations with contiguous RBs within the reduced active UL BWP; and
determine a starting RB for each of a plurality of frequency hops.

11. The WTRU according to claim 10, wherein the reduced active UL BWP is determined by subtracting excluded PRBs from an original active UL BWP according to the PRB exclusion information.

12. The WTRU according to claim 7, wherein PRBs to be excluded from the PUSCH frequency hopping are determined according to characteristics of a measured interference signal.

13. The WTRU according to claim 12, wherein the measured interference signal is a Radio Detection and Ranging (RADAR) signal, and wherein the characteristics of the measured interference signal include one or more of: a carrier frequency, bandwidth, periodicity, dwell time, Angle of Arrival (AoA), and Power Spectral Density (PSD).

14. The WTRU according to claim 12, wherein the WTRU determines, alone or in combination with information received from a network element, the measured interference signal is equal to or greater than a threshold value, and wherein the threshold value is preconfigured, determined dynamically, provided by the network element, or provided by another network element.

15. The WTRU according to claim 14, wherein the signal to trigger PUSCH frequency hopping transmission with PRB exclusion is received when the measured interference signal is equal to or greater than the threshold value.

16. A method of triggering Physical Uplink Shared Channel (PUSCH) frequency hopping transmission implemented by a network element, the method comprising:
identifying an interference signal;
determining the interference signal is equal to or greater than a threshold value;
determining one or more wireless transmit/receive units (WTRUs) capable of incurring the interference signal at a level equal to or greater than the threshold value;
generating Physical Resource Block (PRB) exclusion information, the PRB exclusion information identifying PRBs excluded from the PUSCH frequency hopping transmission; and
transmitting a signal to trigger the PUSCH frequency hopping transmission with PRB exclusion.

17. The method according to claim 16, further comprising determining characteristics of the interference signal.

18. The method according to claim 17, wherein the interference signal is a Radio Detection and Ranging (RADAR) signal, and wherein the characteristics of the interference signal include one or more of: a carrier frequency, bandwidth, periodicity, dwell time, Angle of Arrival (AoA), and Power Spectral Density (PSD).

19. The method according to claim 16, wherein the threshold value is preconfigured, determined dynamically, provided by the network element, or provided by another network element.
